(19) United States
(12) Patent Application Publication
(10) Pub. No.: US 2006/0006071 A1
(43) Pub. Date: Jan. 12, 2006

(54) Method for improving electroplating in sub-0.1um interconnects by adjusting immersion conditions

(76) Inventors: Guangli Che, Albuquerque, NM (US); Vinay B. Chikarmane, Portland, OR (US); Christopher D. Thomas, Aloha, OR (US); Robert I. Wu, Portland, OR (US); Daniel J. Zierath, Portland, OR (US)

Correspondence Address: INTEL/BLAKELY, 12400 WILSHIRE BOULEVARD, SEVENTH FLOOR, LOS ANGELES, CA, 90025-1030, US

(21) Appl. No.: 11/225,493

(22) Filed: Sep. 12, 2005

Related U.S. Application Data
(62) Division of application No. 10/454,719, filed on Jun. 3, 2003.

(51) Int. Cl. C25D 21/12; B23H 3/02

(52) U.S. Cl. 205/82; 205/84; 204/228.7; 204/228.8

(57) ABSTRACT

Embodiments of the invention provide methods of reducing electroplating defects by adjusting immersion conditions. For one embodiment, the immersion conditions are adjusted based upon characteristics of the substrate, including feature size. Additionally or alternatively, the immersion conditions may be adjusted based upon aspects of the electroplating process, including motion of the substrate upon immersion. Immersion conditions that may be adjusted in accordance with various embodiments of the invention include entry bias voltage/current, vertical immersion speed, and angle of immersion.

This is a Divisional application of Ser. No. 10/454,719 filed Jun. 3, 2003, which is presently pending.

### FIELD

Embodiments of the invention relate generally to the field of electroplating integrated circuit substrates and, more particularly, methods for adjusting immersion conditions to reduce defects and improve electroplating in sub-0.1 um interconnects.

### BACKGROUND

During the manufacture of integrated circuits, a semiconductor wafer is deposited with a conductive metal to provide interconnects between the integrated components. Aluminum deposition may be used for this purpose. Copper has recently been found to offer distinct advantages over aluminum as a conductive plating for an integrated circuit substrate. Copper is more conductive than aluminum and can be plated into much smaller features (e.g., trenches and vias) having high aspect ratios. This is an important advantage given the trend toward smaller features. Moreover, the deposition process for aluminum is more costly and complex, requiring thermal processing within a vacuum, whereas electroplating can be used to effect copper plating of semiconductor wafers.

However, a substantial drawback to the use of copper plating is the variety of defects that can occur in the copper plating. During electroplating and subsequent processing, a variety of critical or killer defects can be developed. Critical defects include, for example, a “pit” or “crater” defect, which is a hole in the copper plating that extends to the seed layer. The unplated area of the wafer will be destroyed in subsequent processing, so substrates having critical defects in their copper plating may be discarded.

Other types of defects include voids and seams that are the result of poor gapfill. Prior to plating, the semiconductor wafer is patterned with vias and trenches that form the interconnections; that is, vias provide the interconnection through the chip, and trenches provide the interconnections across the chip. FIG. 1 illustrates the voids and seams that may occur when electroplating surfaces having small features, in accordance with the prior art. As shown in FIG. 1, the substrate 100 has a number of features labeled 105A-105D that may be trenches or vias. Voids 106, as shown in features 105A and 105C, or seams 107, as shown in features 105B and 105D, may form over the features. This problem is more pronounced for smaller features. This problem is addressed by adding a suppressant and accelerator to the electroplating solution to suppress copper plating outside the features (in the field regions 115) while accelerating copper deposition at the bottom of the features. The accelerator allows the copper plating to grow faster from within the features, filling the features from the bottom up to avoid the formation of holes and seams in the copper plating. This solution is not always effective.

Typical electroplating schemes employ immersion conditions that may exacerbate the problem of defect formation. For example, typical electroplating schemes provide an entry voltage of several volts. This entry voltage is used to prevent etching of the seed layer as the wafer enters the electroplating solution and is not well regulated. When the entire wafer is immersed in the electroplating solution and is no longer subject to erratic movement due to entry, then a regulated voltage is applied to accomplish the electroplating. The problem is that the entry voltage can cause plating to commence in an unregulated and undesired manner. That is, plating may commence on a portion of the wafer (the portion immersed), while the remainder of the wafer is still outside the electroplating solution. Also, the entry voltage may cause hydrogen bubbles to form in the electroplating solution, thereby degrading whatever plating is occurring. Electroplating processes employing such entry voltages were developed at a time when feature sizes were larger than today (i.e., greater than 0.1 um). The detrimental affect of these immersion conditions on prior art electroplating was not critical because of the larger feature sizes. That is, the initial unregulated plating was not enough to fill the features and cause voids or seams as described above. However, as feature size becomes smaller, the unregulated plating can actually fill the features, causing voids or seams, or have other undesirable effects.

Other initial immersion conditions of a typical electroplating scheme that may produce a variety of defects include the angle at which a wafer is immersed in the electroplating solution, as well as the immersion velocity.

### BRIEF DESCRIPTION OF THE DRAWINGS

The invention may be best understood by referring to the following description and accompanying drawings that are used to illustrate embodiments of the invention. In the drawings:

FIG. 1 illustrates the voids and seams that may occur in electroplating surfaces having small features, in accordance with the prior art;

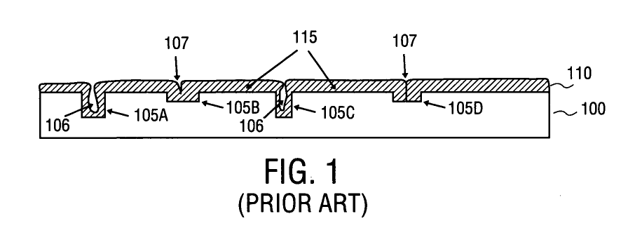

FIG. 2 illustrates a process by which wafer immersion conditions are determined, in accordance with one embodiment of the invention;

FIG. 3 illustrates a process by which a wafer having sub-0.1 um features is electroplated, in accordance with one embodiment of the present invention;

FIG. 4 illustrates the immersion of a wafer into an electroplating solution at a Zspeed and angle of immersion selected, in accordance with an embodiment of the invention;

FIG. 5 illustrates the relationship between the number of pit defects and Zspeed, in accordance with one embodiment of the invention; and

FIG. 6 illustrates a portion of an electroplating process by which a wafer having sub-0.1 um features is electroplated, in accordance with one embodiment of the present invention.

### DETAILED DESCRIPTION

Embodiments of the invention provide methods for electroplating a substrate that substantially reduce a variety of defects. For one embodiment, the wafer conditions and electroplating process are evaluated and immersion conditions are determined based upon the evaluation. For one such embodiment, an entry voltage or entry current is selected, based upon feature size and seed layer thickness, which provides a substantial reduction in the occurrence of voids or seams. Additionally, or alternatively, in various alternative embodiments, the wafer immersion equipment and/or the motion of the wafer upon entering the electroplating solution may be used as factors in determining the angle of immersion or immersion velocity to substantially reduce pit defects.

In the following description, numerous specific details are set forth. However, it is understood that embodiments of the invention may be practiced without these specific details. In other instances, well-known structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

### Process

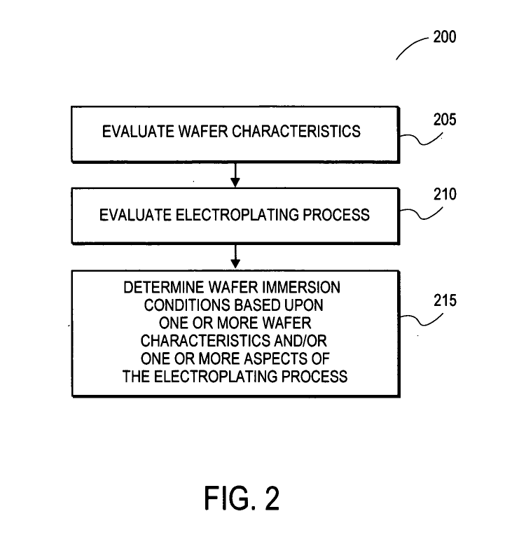

FIG. 2 illustrates a process by which wafer immersion conditions are determined in accordance with one embodiment of the invention. Process 200, shown in FIG. 2, begins at operation 205 in which the wafer characteristics are evaluated. For one embodiment, one or more characteristics of the wafer, including such characteristics as wafer diameter, feature dimensions (size and aspect ratio), and seed layer thickness, are considered.

At operation 210 the electroplating process is evaluated. For one embodiment, one or more aspects of the electroplating process, including wafer motion upon immersion and the specific electroplating tool in use are considered.

At operation 215 one or more wafer characteristics and/or one or more aspects of the electroplating process are used to determine wafer immersion conditions in order to substantially reduce a variety of defects over the prior art electroplating methods. For one embodiment, such wafer immersion conditions include the initial bias voltage or current of the electroplating solution as well as the velocity and angle of wafer immersion. The type and extent of defect reduction for each of these wafer immersion conditions is discussed in more detail below.

### Entry Voltage or Current

Typically, prior to the electroplating process, a seed layer of copper is applied to the wafer. The seed layer provides an electrical path across the wafer surface to facilitate the electroplating. The seed layer is applied by means other than electroplating, typically in a vacuum deposition through a sputtering process, and is typically much thinner than the desired electroplate thickness. The acids within the electroplating solution may etch the copper seed layer, and if the copper seed layer is etched completely through, the wafer can be destroyed. An entry bias voltage is applied to prevent the acids of the electroplating solution from etching the copper seed layer. However, if the entry bias voltage is not carefully determined, detrimental, unregulated electroplating occurs. For example, when the wafer is immersed in the electroplating solution, all portions of the wafer are not immediately immersed. That is, due to the angle of immersion and the time required for the wafer to become completely immersed, some portions of the wafer are immersed before others. This can cause unregulated electroplating plating, as discussed above. Depending upon feature size and aspect ratio, such unregulated electroplating may fill the features, causing voids or seams, or may apply a degraded electroplate due to hydrogen bubbles. Therefore, it is desirable that electroplating does not occur until the entire wafer is immersed and the amount of hydrogen bubbles within the electroplating solution is reduced.

In accordance with one embodiment of the invention, an entry bias voltage or current is applied that is sufficient to prevent detrimental etching of the copper seed layer while avoiding excessive unregulated electroplating and hydrogen production. The wafer enters the electroplating solution, completing a circuit, and causing a current to flow. The magnitude of this current can be described as the current that flows based upon the applied, regulated voltage and the resistance of the electroplating cell and the copper seed layer, or the current that flows based on direct current regulation by the power supply.

Empirically, a suitable regulated entry bias current to substantially reduce voids and seams for sub-0.1 um feature size has been determined to be from 0 A to 1 A (0 A is regulated, as a floating wafer will have a small negative current).

For typical electroplating schemes, the entry bias voltage sufficient to prevent etching of the copper seed layer is approximately 0.3V. However, etching of the copper seed layer is not a controlled process and does not take place uniformly. Reduced etching, for even a small period, could cause a hole in the cooper seed layer and destroy the wafer. Therefore, the entry bias voltage should be chosen high enough to avoid etching, especially where relatively thin copper seed layers are employed. The entry bias voltage sufficient to substantially reduce feature electroplating for sub-0.1 um features is approximately 0.8V (depending upon aspect ratio). Therefore, for one embodiment of the invention, an entry bias voltage between 0.3V and 0.8V is sufficient to prevent detrimental etching while substantially reducing detrimental electroplating. If the seed layer is less susceptible to etching (e.g., the copper seed layer is thicker, or the seed layer is a more robust material), the entry bias voltage may be selected closer to 0.3V in order to reduce electroplating. Also, as feature sizes become smaller, the entry bias voltage may be selected closer to 0.3V so that any electroplating that does occur does not result in filling the feature during immersion.

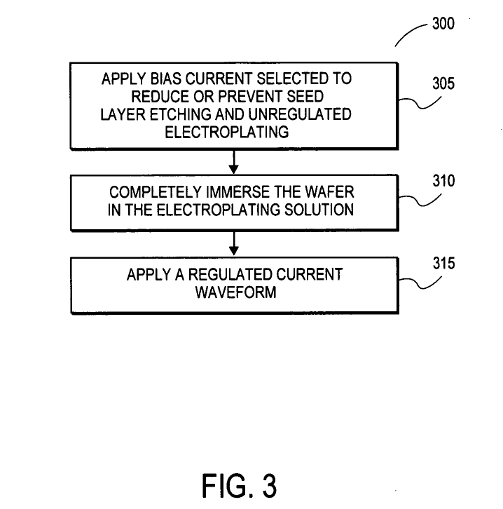

FIG. 3 illustrates a process by which a wafer having sub-0.1 um features is electroplated in accordance with one embodiment of the present invention. Process 300, shown in FIG. 3, begins with operation 305 in which a power supply is attached to the wafer and the electroplating cell anode. The applied bias voltage is within a range such that etching of the copper seed layer is prevented or substantially inhibited and substantial electroplating is avoided. Such an applied voltage produces less hydrogen bubbles in comparison with prior art electroplating schemes.

At operation 310 the wafer is immersed into the electroplating solution. At this point, due to the applied voltage level, there is little or no electroplating. Therefore, unregulated electroplating, and electroplating in the presence of hydrogen bubbles, is reduced.

At operation 315, when the wafer has been entirely immersed in the electroplating solution, a regulated current waveform, as known in the art, is applied. Such current waveform is designed to promote gapfill for the given feature dimensions.

### Immersion Velocity and Angle of Immersion

Both velocity and angle of immersion of the wafer may be the source of a variety of wetting defects, including pit defects. For example, the downward vertical velocity (“Zspeed”) of a wafer as it enters the electroplating solution is related to the occurrence of pit defects. Also, reducing the angle of immersion reduces the number of pit defects.

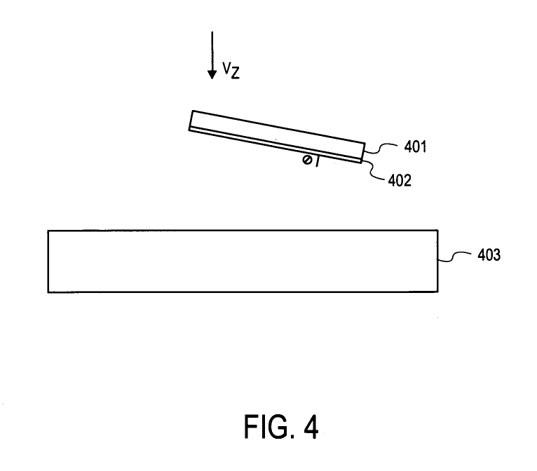

FIG. 4 illustrates the immersion of a wafer into an electroplating solution at the Zspeed and the angle of immersion selected, in accordance with an embodiment of the invention. As shown in FIG. 4, wafer 401, having a seed layer 402, is immersed into an electroplating solution 403 with a velocity V_{Z} at an angle θ. In accordance with one embodiment of the invention, Vector V_{Z}, representing the Zspeed of a wafer as it enters the electroplating solution, has been selected to substantially reduce pit defects in comparison to prior art electroplating schemes. Angle θ, indicating the angle of the wafer in relation to the electroplating solution as the wafer is immersed, likewise has been selected to reduce pit defects in accordance with one embodiment of the invention.

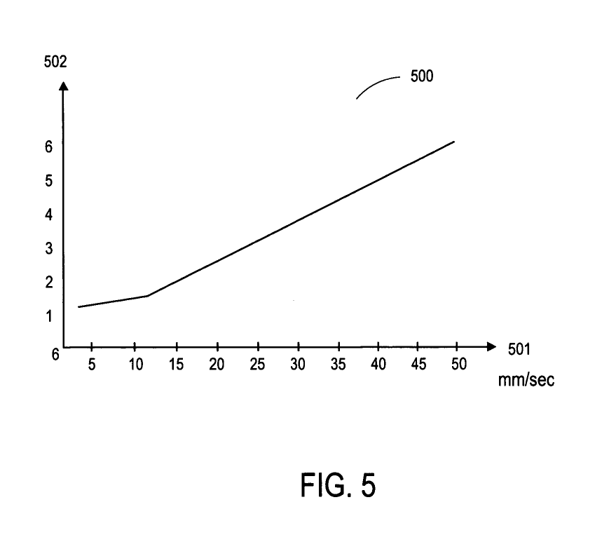

Empirically it is determined that Zspeeds in excess of 12 mm/sec result in a proportional increase in pit defects. FIG. 5 illustrates the relationship between the number of pit defects and Zspeed in accordance with one embodiment of the invention. Graph 500, shown in FIG. 5, has an axis 501 representing Zspeed in mm/sec and an axis 502 representing the occurrence of pit defects. As shown in FIG. 5, an electroplating scheme employing a Zspeed of approximately 50 mm/sec (e.g., prior art schemes) has a proportionately higher occurrence of pit defects than an electroplating scheme, in accordance with one embodiment of the invention, employing a Zspeed of 12 mm/sec. As shown in FIG. 5, Zspeeds less than 12 mm/sec result in less pit defects, though not proportionately less, and therefore 12 mm/sec is selected for the Zspeed, in accordance with one embodiment of the invention, to substantially reduce the number of pit defects while maintaining electroplating throughput.

The reduction of pit defects as a function of Zspeed and angle of immersion is dependent upon aspects of the electroplating process, including the motion of the wafer upon immersion and the type of immersion equipment used. Therefore, in accordance with one embodiment of the invention, aspects of the electroplating process are evaluated to determine a Zspeed and angle of immersion that will reduce pit defects and other wetting-related defects.

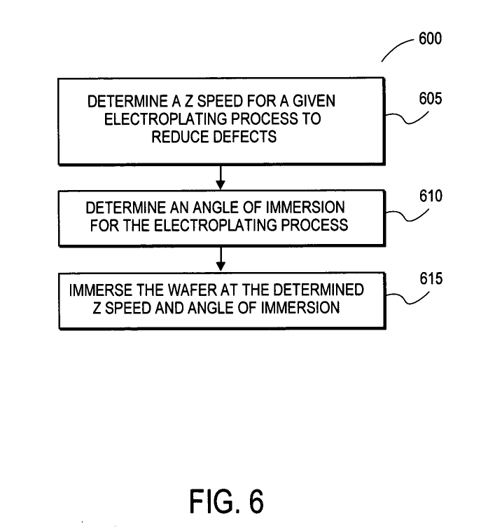

FIG. 6 illustrates a portion of an electroplating process by which a wafer having sub-0.1 um features is electroplated in accordance with one embodiment of the present invention. Process 600, shown in FIG. 6, begins with operation 605 in which a Zspeed is determined for a given electroplating process. The immersion velocity may be determined empirically, or estimated by considering the various aspects of the electroplating process, including the specific electroplating tool and the motion of the wafer upon immersion.

At operation 610, an angle of immersion is determined for the electroplating process. The angle of immersion, likewise, may be determined empirically or through consideration of the particular electroplating process.

At operation 615 the wafer is immersed at the determined Zspeed and angle of immersion.

### General Matters

Embodiments of the invention have been described in reference to a silicon wafer having a copper seed layer. In alternative embodiments, the wafer could be any suitable material, including semiconductors and ceramics. Likewise, the seed layer may be any suitable material, including alloys of copper and sliver or gold, or multilayers of such materials.

Moreover, while embodiments of the invention have been described as applicable to wafers having relatively small feature sizes (i.e., less than 0.1 um), alternative embodiments of the invention are applicable to other feature sizes, larger or smaller. For example, wafers having larger features but, with relatively high aspect ratios, would benefit from embodiments of the invention.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1-8. (canceled)

9. An apparatus comprising:
a substrate having one or more features formed thereon; and
a layer of conductive metal formed on the substrate through an electroplating process applying an entry bias current that substantially reduces etching of a seed layer by acid with an electroplating solution, the entry bias current also substantially reducing unregulated electroplating during immersion of the substrate into the electroplating solution, and subsequently applying a regulated current waveform such that the one or more features are filled, the electroplating process helping to reduce the occurrence of voids or seams in the layer of conductive metal.

10. The apparatus of claim 9 wherein the substrate comprises a semiconductor wafer and the layer of conductive metal comprises a layer of copper.

11. The apparatus of claim 9 wherein at least one of the features has dimensions of less than 0.1 um.

12. The apparatus of claim 11 wherein the entry bias current is in the range of 0 A-1 A.

13. A method comprising:
applying an entry bias voltage to a substrate having a metal seed layer deposited thereon and a plating cell anode, the entry bias voltage selected to help reduce etching of the metal seed layer and helping to reduce unregulated electroplating of the substrate;
completely immersing the wafer in an electroplating solution; and
applying a regulated current waveform to electroplate a desired metal layer on the substrate.

14. The method of claim 13 wherein the entry bias voltage is selected such that substantially no etching of the metal seed layer occurs and substantially no unregulated electroplating of the substrate occurs.

15. The method of claim 13 wherein the substrate has a plurality of features formed thereon and the entry bias voltage is selected such that unregulated electroplating during immersion does not fill the features.

16. The method of claim 15 wherein at least one of the features has a dimension of less than 0.1 um and the entry bias voltage is between 0.3V and 0.8V.

17. The method of claim 15 wherein the substrate comprises a semiconductor wafer and the metal seed layer comprises a copper layer.

18. The method of claim 16 wherein the entry bias voltage is selected based upon the dimension of the at least one feature and an aspect ratio of the at least one feature.

19-24. (canceled)
